(19) United States
(12) Patent Application Publication
(10) Pub. No.: US 2020/0331007 A1
(43) Pub. Date: Oct. 22, 2020

(54) INTERCHANGEABLE SHOWER HEAD ATTACHMENT

(71) Applicant: Robert Allen Dierickx, Muscatine, IA (US)

(72) Inventor: Robert Allen Dierickx, Muscatine, IA (US)

(21) Appl. No.: 16/704,018

(22) Filed: Dec. 5, 2019

Related U.S. Application Data
(60) Provisional application No. 62/836,010, filed on Apr. 18, 2019.

(51) Int. Cl. B05B 1/18; B05B 1/16; A61C 17/032

(52) U.S. Cl. CPC B05B 1/185; A61C 17/032; B05B 1/16

(57) ABSTRACT

An attachment for a shower head; the attachment includes a connector, a fluid-line connector, a fluid-line, and at least two interchangeable-heads: one being a water flossing device and another being a hand unit for washing hard to reach body parts. The attachment may cleanse the body from head to toe in the shower, improving overall hygiene of a user.

### CROSS REFERENCE TO RELATED APPLICATION

The present application is related to and claims priority to U.S. Provisional Patent Application No. 62/836,010 filed Apr. 18, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of personal hygiene and more specifically relates to shower head attachments.

### 2. Description of Related Art

Water picks, or devices that floss the teeth with water pressure, are widely popular and recommended by many dentists. Unfortunately, they can create a mess on bathroom sinks, countertops, and mirrors. They also rely on electricity to create water pressure, which can be dangerous. Additionally, people may struggle to clean their back, feet, and other areas of the body that involve twisting and bending. This can be especially problematic for people with limited mobility, pregnant women, and many others. A suitable solution is desired.

U.S. Pub. No. 2006/0161120 to Timothy Hoenig relates to a shower system. The described shower system includes a connector that can connect to an output of a shower head to deliver a flow of fluid through a fluid conduit to an applicator for delivery of a fluid flow and/or cleaning agent to a target area. A variety of different applicators may be removably attached to a distal end of the fluid conduit. Thus, a user may be able to use the same fluid conduit for douching, cleaning teeth, cleaning the user's back, and/or cleaning the bathtub.

### BRIEF SUMMARY OF THE INVENTION

In view of the foregoing disadvantages inherent in the known personal hygiene art, the present disclosure provides a novel interchangeable shower head attachment. The general purpose of the present disclosure, which will be described subsequently in greater detail, is to provide an efficient, safe, and convenient cleanse in the shower from head to toe, including in between the teeth, improving a user's overall hygiene. It may effectively prevent messes on sinks, countertops, and mirrors from traditional water picks. Further, it may save people a considerable amount of time and frustration during their morning routine, and assists people with limited mobility.

An attachment is disclosed herein. The attachment includes a connector for attachment to a shower head. The connector may be placed in fluid communication with a main water supply of a building when connected to the shower head. A fluid-line connector may be attached to the connector, and a fluid-line may be attached to the fluid-line connector at a first-end of the fluid-line. The fluid-line may be configured to receive water from the main water supply of the building therethrough.

At least two interchangeable-heads may each configured for attachment about a second-end of the fluid-line. The at least two interchangeable heads may include a first interchangeable-head which may include a first handle-end graspable by a user, a flossing-end, and a first-conduit therebetween. The first-conduit may be configured to receive the water from the main water supply of the building therethrough. The flossing-end may include a tip may have a flossing-aperture configured to expel the water therethrough; the first interchangeable-head being configured to water-floss teeth of the user.

Further, a second interchangeable-head may include a second handle-end graspable by the user, a washing-end, and a second-conduit therebetween. The second-conduit may be configured to receive the water from the main water supply of the building therethrough. The washing-end may include a plurality of washing-apertures configured to expel the water therethrough; the second interchangeable head being configured to wash a hard-to-reach body part of the user.

A method of using attachment is also disclosed herein. The method of using attachment may comprise the steps of: providing the attachment as above; connecting the attachment to the shower head via the connector; attaching the first interchangeable-head to the second-end of the fluid-line; turning on the main water supply to the shower head; and using the first interchangeable-head to floss teeth via the water expelled through the flossing-aperture.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an interchangeable shower head attachment, constructed and operative according to the teachings of the present disclosure.

FIG. 1A is a side perspective view of the attachment during an ‘in-use’ condition, according to an embodiment of the disclosure.

FIG. 1B is a rear perspective view of the attachment during an ‘in-use’ condition, according to an embodiment of the disclosure.

FIG. 2A is a side front perspective view of the attachment of FIG. 1A, according to an embodiment of the present disclosure.

FIG. 2B is a side front perspective view of the attachment of FIG. 1A, according to an embodiment of the present disclosure.

FIG. 3A is a side front perspective view of the attachment of FIG. 1A, according to an embodiment of the present disclosure.

FIG. 3B is a side front perspective view of the attachment of FIG. 1A, according to an embodiment of the present disclosure.

FIG. 4 is a front perspective view of the attachment of FIG. 1A, according to an embodiment of the present disclosure.

FIG. 5 is a flow diagram illustrating a method of use for attachment, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to personal hygiene and more particularly to an interchangeable shower head attachment as used to improve the use of shower head attachments.

Generally, disclosed is a device including a T fitting for connection to a standard shower head. The T fitting may include a tube connection and a pressure/flow regulator valve to control water pressure. Attached to the fitting at the tube connection may be a water line. On an opposite end of the water line may be a connection for securing interchangeable heads, including a floss tip and a hand wand. In use, the floss tip may use water pressure from the shower head to clean in-between the teeth, while the hand wand may be used to clean the back, feet, and other hard-to-reach places.

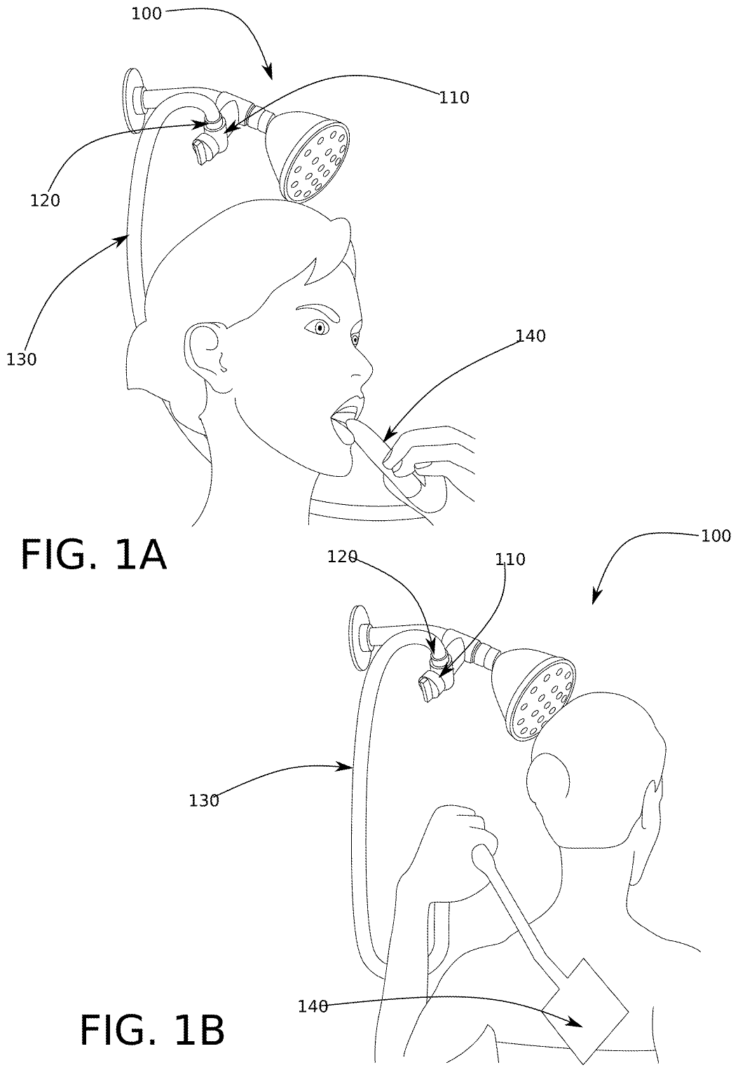

Referring now more specifically to the drawings by numerals of reference, there is shown in FIGS. 1A-5, various views of an attachment 100.

FIGS. 1A-1B show an attachment 100 during an ‘in-use’ condition 150, according to an embodiment of the present disclosure. As Illustrated, the attachment 100 may include a connector 110, a fluid-line connector 120, a fluid-line 130, and at least two interchangeable-heads 140. The attachment 100 may be used for attachment to a shower head 5, the shower head 5 being connected to a main water supply of a building.

According to one embodiment, the attachment 100 may be arranged as a kit. The kit may include a set of user instructions. The instructions may detail functional relationships in relation to the structure of the attachment 100 (such that the attachment 100 can be used, maintained, or the like, in a preferred manner).

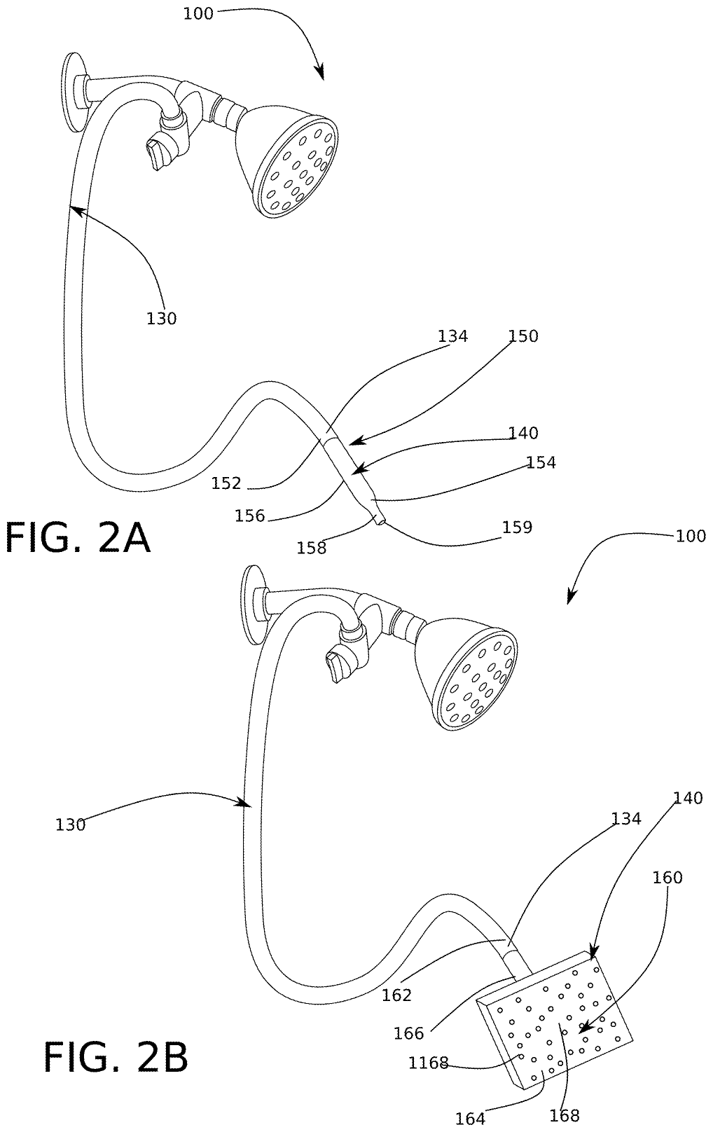

FIGS. 2A-2B show side front perspective view of the attachment 100 of FIG. 1A, according to an embodiment of the present disclosure. The fluid-line 130 may be configured to receive water from the main water supply of the building therethrough. Preferably, the fluid-line 130 may be flexible and/or bendable, to allow the user freedom of motion with the attachment. Further, the fluid-line 130 may be tangle-free. In one embodiment, the fluid-line 130 may include a thickness of between 0.125-2 inches. In addition, the fluid-line 130 may include a length of between 4-10 feet, which again, may allow freedom of motion, but prevent tangling of the fluid-line 130. It should be appreciated that specifications may vary and are not limited to the measurements listed here.

As shown, the at least two interchangeable-heads 140 may each be configured for attachment about a second-end 134 of the fluid-line 130, the at least two interchangeable heads 140 including at least a first interchangeable-head 150 and a second interchangeable-head 160. However, it should be appreciated that the attachment 100 is not limited to just the first interchangeable head 150 and the second interchangeable head 160.

The first interchangeable-head 150 may preferably be configured to water-floss teeth of a user. The first interchangeable-head 150 may include a first handle-end 152 graspable by the user, a flossing-end 154, and a first-conduit 156 therebetween. The first-conduit 156 may be configured to receive the water from the main water supply of the building therethrough and the flossing-end 154 may include a tip 158 having a flossing-aperture 159 configured to expel the water therethrough. The flossing-aperture 159 may be sized to permit a concentrated stream of water to flow between the teeth of the user. In one embodiment, the flossing-aperture 159 may be 5/64 inch or about 2 mm. In some embodiments, the tip 158 may include a slight bend of at least 10 degrees. The bend may begin 1 inch down from the flossing-aperture 159. The flossing-aperture 159 may be ⅛ inch on attachments.

The second interchangeable head may be configured to wash a hard-to-reach body part of the user. Particularly, a back area of the user, or feet. The second interchangeable-head 160 may include a second handle-end 162 graspable by the user, a washing-end 164, and a second-conduit 166 therebetween. The second-conduit 166 may be configured to receive the water from the main water supply of the building therethrough and the washing-end 164 may include a plurality of washing-apertures 168 configured to expel the water therethrough. The second conduit-length may be greater than a first conduit-length.

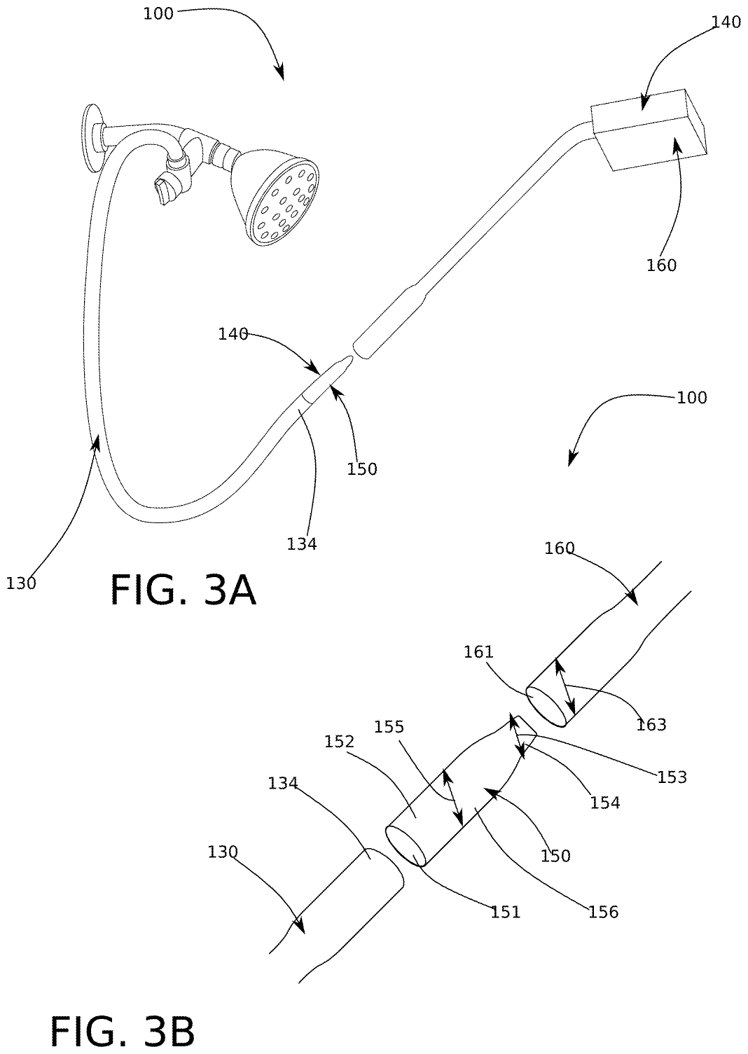

FIGS. 3A-3B show front side perspective view of the attachment 100 of FIG. 1A, according to an embodiment of the present disclosure. As above, the at least two interchangeable-heads 140 may each be configured for attachment about a second-end 134 of the fluid-line 130. In one embodiment, this includes the second interchangeable-head 160 being attachable to the first interchangeable-head 150 whilst the first interchangeable-head 150 is attached to the second-end 134 of the fluid-line 130.

The first handle-end 152 may include a first hollow-interior 151. The first hollow-interior 151 may be configured to receive the second-end 134 of the fluid-line 130 therein, to attach the first interchangeable-head 150 to the fluid-line 130. As mentioned above, the second interchangeable-head 160 may be configured for removable attachment to the first interchangeable-head 150. In one embodiment, to allow for this attachment, the flossing-end 154 may be tapered and the second handle-end 162 may include a second hollow-interior 161 configured to receive the flossing-end 154, to attach the second interchangeable-head 160 to the first interchangeable-head 150.

Further, the second hollow-interior 161 may include a handle-diameter 163 greater than an end-diameter 153 of the flossing-end 154. This may allow the flossing-end 154 to slide into the second hollow-interior 161. The handle-diameter 163 may be substantially equal to the a conduit-diameter 155 of the first-conduit 156, such that once the first interchangeable-head 150 is slid into the second interchangeable-head 160, past the tapered area, the first interchangeable-head 150 and the second interchangeable-head 160 hold together due to the similarity in diameters.

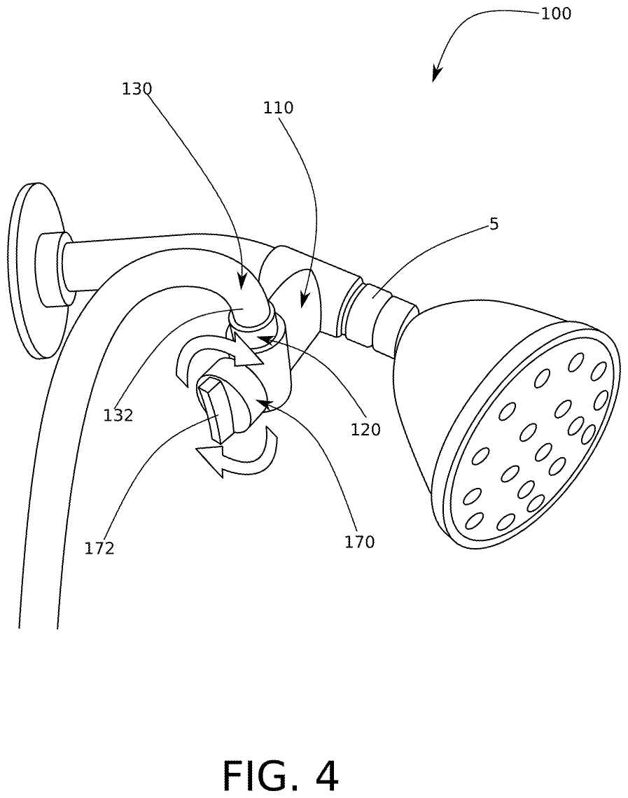

FIG. 4 shows a side perspective view of the attachment 100 of FIG. 1A, according to an embodiment of the present disclosure. The connector 110 may be used for attachment to the shower head 5, the connector 110 being placed in fluid communication with the main water supply of the building when connected to the shower head 5. Further, the fluid-line connector 120 may be attached to the connector 110, and the fluid-line 130 may be attached to the fluid-line connector 120 at a first-end 132 of the fluid-line 130. Preferably, the connector 110 may be a T-fitting. However, other connectors are contemplated, such as a Y-fitting or the like.

A valve assembly 170 may be provided with the attachment 100. As shown, the valve assembly 170 may be attached to the connector 110. Preferably, the valve assembly 170 may be configured to regulate a flow of the water. In one embodiment, the valve assembly 170 may be configured to shut off the flow of the water to the attachment 100, but keep the water flowing through the shower head 5. Further, the valve assembly 170 may be configured to regulate a pressure of the water. This may be particularly useful when the first interchangeable-head 150 is in use (FIG. 1A), as higher water pressure may be desired when water flossing the teeth. Preferably, the valve assembly 170 may include a dial 172 for adjusting the flow and the pressure.

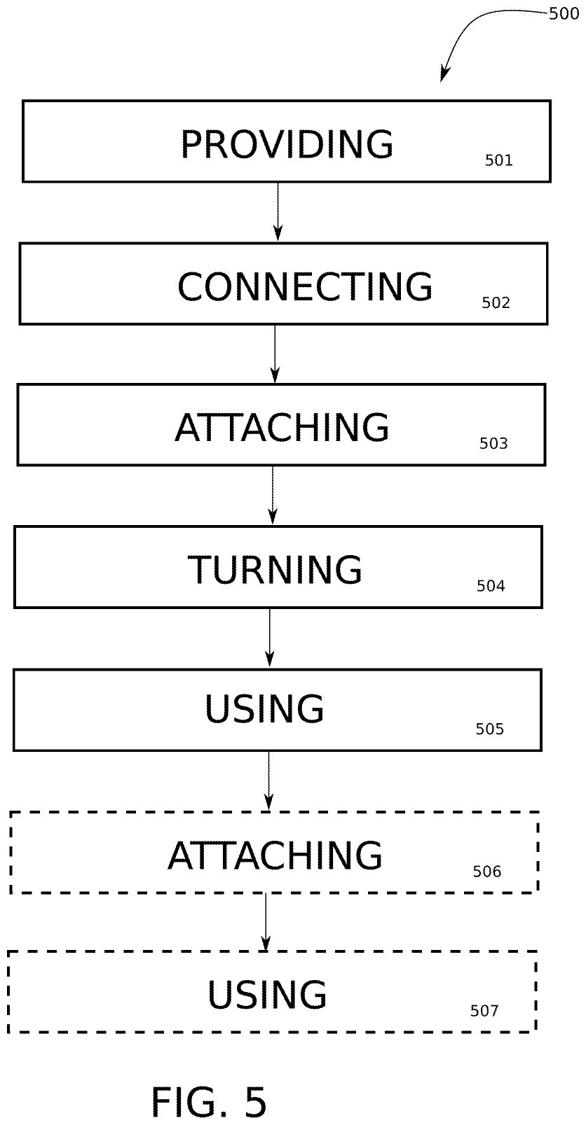

FIG. 5 is a flow diagram illustrating a method of using an attachment for a shower head 500, according to an embodiment of the present disclosure. As illustrated, the method of using an attachment for a shower head 500 may include the steps of: providing 501 the attachment as above; connecting 502 the attachment to the shower head via the connector; attaching 503 the first interchangeable-head to the second-end of the fluid-line; turning 504 on the main water supply to the shower head; and using 505 the first interchangeable-head to floss teeth via the water expelled through the flossing-aperture. Further steps may include: attaching 506 the second interchangeable-head about the second-end of the fluid-line; and using 507 the second interchangeable-head to wash the hard-to-reach body part of the user via the water expelled by the plurality of washing-apertures.

It should be noted that steps 506 and 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for attachment 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An attachment for a shower head, the shower head being connected to a main water supply of a building, the attachment comprising:
a connector for attachment to the shower head, the connector being placed in fluid communication with the main water supply of the building when connected to the shower head;
a fluid-line connector attached to the connector;
a fluid-line attached to the fluid-line connector at a first-end of the fluid-line, the fluid-line being configured to receive water from the main water supply of the building therethrough; and
at least two interchangeable-heads each configured for attachment about a second-end of the fluid-line, the at least two interchangeable heads including:
a first interchangeable-head including a first handle-end graspable by a user, a flossing-end, and a first-conduit therebetween, the first-conduit configured to receive the water from the main water supply of the building therethrough, the flossing-end including a tip having a flossing-aperture configured to expel the water therethrough, the first interchangeable-head being configured to water-floss teeth of the user; and
a second interchangeable-head including a second handle-end graspable by the user, a washing-end, and a second-conduit therebetween, the second-conduit configured to receive the water from the main water supply of the building therethrough, the washing-end including a plurality of washing-apertures configured to expel the water therethrough, the second interchangeable head being configured to wash a hard-to-reach body part of the user.

2. The attachment of claim 1, wherein the first handle-end includes a first hollow-interior configured to receive the second-end of the fluid-line therein, to attach the first interchangeable-head to the fluid-line.

3. The attachment of claim 1, wherein the second interchangeable-head is configured for removable attachment to the first interchangeable-head.

4. The attachment of claim 3, wherein the flossing-end is tapered.

5. The attachment of claim 4, wherein the second handle-end includes a second hollow-interior configured to receive the flossing-end, to attach the second interchangeable-head to the first interchangeable-head.

6. The attachment of claim 5, wherein the second hollow-interior includes a handle-diameter greater than an end-diameter of the flossing-end.

7. The attachment of claim 6, wherein the handle-diameter is substantially equal to a conduit-diameter of the first-conduit.

8. The attachment of claim 1, further comprising a valve assembly configured to regulate a flow of the water.

9. The attachment of claim 8, wherein the valve assembly is further configured to regulate a pressure of the water.

10. The attachment of claim 9, wherein the valve assembly includes a dial.

11. The attachment of claim 10, wherein the valve assembly is attached to the connector.

12. The attachment of claim 11, wherein the connector is a T-fitting.

13. The attachment of claim 1, wherein the fluid-line is flexible.

14. The attachment of claim 13, wherein the fluid-line includes a thickness of between 0.125-2 inches.

15. The attachment of claim 13, wherein the fluid-line includes a length of between 4-10 feet.

16. The attachment of claim 1, wherein a second conduit-length is greater than a first conduit-length.

17. An attachment for a shower head, the shower head being connected to a main water supply of a building, the attachment comprising:
a connector for attachment to the shower head, the connector being placed in fluid communication with the main water supply of the building when connected to the shower head;
a fluid-line connector attached to the connector;
a fluid-line attached to the fluid-line connector at a first-end of the fluid-line, the fluid-line being configured to receive water from the main water supply of the building therethrough; and
at least two interchangeable-heads each configured for attachment about a second-end of the fluid-line, the at least two interchangeable heads including:
a first interchangeable-head including a first handle-end graspable by a user, a flossing-end, and a first-conduit therebetween, the first-conduit configured to receive the water from the main water supply of the building therethrough, the flossing-end including a tip having a flossing-aperture configured to expel the water therethrough, the first interchangeable-head being configured to water-floss teeth the user; and
a second interchangeable-head including a second handle-end graspable by the user, a washing-end, and a second-conduit therebetween, the second-conduit configured to receive the water from the main water supply of the building therethrough, the washing-end including a plurality of washing-apertures configured to expel the water therethrough, the second interchangeable head being configured to wash a hard-to-reach body part of the user; and
a valve assembly configured to regulate a flow of the water; and
wherein the first handle-end includes a first hollow-interior configured to receive the second-end of the fluid-line therein, to attach the first interchangeable-head to the fluid-line;
wherein the second interchangeable-head is configured for removable attachment to the first interchangeable-head;
wherein the flossing-end is tapered;
wherein the second handle-end includes a second hollow-interior configured to receive the flossing-end, to attach the second interchangeable-head to the first interchangeable-head;
wherein the second hollow-interior includes a handle-diameter greater than an end-diameter of the flossing-end;
wherein the handle-diameter is substantially equal to a conduit-diameter of the first-conduit;
wherein the valve assembly is further configured to regulate a pressure of the water;
wherein the valve assembly includes a dial;
wherein the valve assembly is attached to the connector;
wherein the connector is a T-fitting;
wherein the fluid-line is flexible; and
wherein a second conduit-length is greater than a first conduit-length.

18. The attachment of claim 17, further comprising set of instructions; and
wherein the attachment is arranged as a kit.

19. A method of using an attachment for a shower head, the shower head being connected to a main water supply of a building, the method comprising the steps of:
providing the attachment including:
a connector for attachment to the shower head, the connector being placed in fluid communication with the main water of the building when connected to the shower head;
a fluid-line connector attached to the connector;
a fluid-line attached to the fluid-line connector at a first-end of the fluid-line, the fluid-line being configured to receive water from the main water supply of the building therethrough; and
at least two interchangeable-heads each configured for attachment about a second-end of the fluid-line, the at least two interchangeable heads including:
a first interchangeable-head including a first handle-end graspable by a user, a flossing-end, and a first-conduit therebetween, the first-conduit configured to receive the water from the main water supply of the building therethrough, the flossing-end including a tip having a flossing-aperture configured to expel the water therethrough, the first interchangeable-head being configured to water-floss teeth the user; and
a second interchangeable-head including a second handle-end graspable by the user, a washing-end, and a second-conduit therebetween, the second-conduit configured to receive the water from the main water supply of the building therethrough, the washing-end including a plurality of washing-apertures configured to expel the water therethrough, the second interchangeable head being configured to wash a hard-to-reach body part of the user;
connecting the attachment to the shower head via the connector;
attaching the first interchangeable-head to the second-end of the fluid-line;
turning on the main water supply to the shower head; and
using the first interchangeable-head to floss teeth via the water expelled through the flossing-aperture.

20. The method of claim 19, further comprising the steps of:
attaching the second interchangeable-head about the second-end of the fluid-line; and
using the second interchangeable-head to wash the hard-to-reach body part of the user via the water expelled by the plurality of washing-apertures.
